(19) United States
(12) Patent Application Publication
(10) Pub. No.: US 2008/0040115 A1
(43) Pub. Date: Feb. 14, 2008

(54) SYSTEM AND METHOD FOR EVALUATING THE DIFFICULTY OF UNDERSTANDING A DOCUMENT

(75) Inventors: Chieko Asakawa, Yokohama-shi (JP); Daisuke Sato, Yamato-shi (JP); Hironobu Takagi, Yokohama-shi (JP)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, Armonk, NY (US)

(21) Appl. No.: 11/686,389

(22) Filed: Mar. 15, 2007

(30) Foreign Application Priority Data
Mar. 17, 2006 (JP) 2006-74222

(51) Int. Cl. G10L 13/08

(52) U.S. Cl. 704/260

(57) ABSTRACT

A system is provided for evaluating the degree of difficulty a user is likely to encounter when trying to understanding the contents of one or more document pages by listening to a voice output from a screen reader. An evaluation value representing the likely degree of difficulty is generated based on a feature amount representing a feature of the page. A collection section collects the user's actual evaluation value of the difficulty and the feature amount of one or more pages where the generated evaluation value is inconsistent with the user's evaluation of the difficulty. A first update section updates the evaluation function on the basis of the feature amount and the evaluation value collected from the user.

### TECHNICAL FIELD

The present invention relates to a system and a method for evaluating the degree of difficulty of understanding a document. In particular, the present invention relates to a system for evaluating the degree of difficulty of understanding the contents of each page in a document by means of voices output from a screen reader.

### BACKGROUND OF THE INVENTION

Screen readers (text-to-speech reading systems) are used, for among other things to allow sight-impaired people to understand text by listening to a voiced representation of the text. A screen reader converts text in a document into audio data, and outputs the audio for a user. Thus, the user may be able to understand the contents of the document by listening to the audio and without looking at a screen. It may be difficult, however, for a user to understand the contents of a document that includes graphics even when the screen reader is used.

Techniques exist that are supposed to help a user understand the contents of graphics based on an audio representation. A known type of conventional screen reader generates an audio representation of display objects (or their alternate texts) that appear in a page in what is referred to as a Z-order. The Z-order of a plurality of display objects treats individual display objects as if they were stacked on the document page with higher priority objects being higher in the stack. The stacking creates an order of generating audio representations of display objects. Nevertheless, even when display objects in a page are represented audibly in the assigned Z-order, it is not always easy to understand the page on which they appear as a whole.

In addition, a technique has been proposed that would analyze the structure of a document by performing image processing on the document. With this technique, it is possible to create an audio representation of a document expressed by using a complicated structure and color information such as gradation. This proposed technique cannot be generally applied since it requires that the analyzed document have a certain regular structure.

Another proposed technique is one that generates a sound field corresponding to the position of a display object on a screen. According to this technique, a voice is produced with a sound quality corresponding to the size of a letter and the type font in which the letter appears. Moreover, the voice is produced in the position in a sound space corresponding to a relative position where the letter is displayed on the screen. However, the accuracy with which positional information can be perceived by listening to a voice is low. For this reason, it is sometimes difficult to understand the contents of graphics described audibly using this technique.

Further, a two dimensional pin display has been used to create a tactile representation of the position of objects. However, many people find it difficult to effectively user tactile representations,

It is often difficult for a sight-impaired person to understand the contents of graphics by using any of above techniques or any other currently known techniques. On the other hand, when a document includes a plurality of pages, some pages can be understood more easily than others. In order to find out which pages can be understood easily, a sight-impaired person must try to understand each of the pages by using a screen reader. This requires an enormous amount of time and effort.

Note that guidelines for evaluating the degree of difficulty in acquiring information have been established for a document generated using HTML (Hyper Text Markup Language). One example of the guidelines is WCAG (Web Content Accessibility Guidelines) made by WAI (Web Accessibility Initiative) of the W3C (The World Wide Web Consortium). An HTML document includes metainformation called a tag. A document structure is defined by using relationships among tags. If a structure defined by using tags conforms to the guidelines, even a sight-impaired person can easily understand the contents in many cases. In contrast, if a structure defined by using tags does not conform to the guidelines, a sight-impaired person has difficulty in understanding the contents in many cases. In short, for a HTML document, it is possible to find out the degree of document difficulty with certain accuracy even when all of the pages in the document are not read aloud by using a screen reader.

However, many graphical objects do not include any HTML tags, making it difficult to use the described guidelines in evaluating the document difficulty. Moreover, while the requirement that a HTML document conform to requirements of the HTML programming language assures there will be consistency among HTML documents, there is no such assurance of consistency in general for most software-generated graphics because there are no consistently required standards governing how the software can generate the graphics. For this reason, it is difficult to create a standard that can be applied in order to uniformly judge the degree of difficulty in understanding the contents of most graphics.

There is a proposed technique that estimates a user's evaluation of information according to users' preferences. With this technique, an evaluation that would be made by a certain user A is estimated on the basis of evaluations that been made by a plurality of users, each having preferences similar to those of the user A. The available descriptions of this technique simply describe a general idea for estimating a given user's evaluation of a document, and do not describe a specific method for applying the technique to a document for a sight-impaired person. For example, evaluations based on users' preferences may have little to do with how easy it would be for a sight-impaired user to understand the document.

Accordingly, an object of the present invention is to provide a system, a method and a program, that can solve the foregoing problems.

### SUMMARY OF THE INVENTION

One embodiment of the present invention is a system for evaluating the degree of difficulty a user is likely to encounter when trying to understand the contents of each of multiple pages in a document by listening to a voice generated by a screen reader. The system includes a first function recording section, a collection section and a first update section. The first function recording section provides an evaluation function for generates the evaluation value of a page on based on a feature amount representing a feature of the page. If the generated evaluation value is inconsistent with a user's evaluation of the difficulty, the collection section collects the user's evaluation value and the feature amount of the page. The first update section updates the evaluation function in the first function recording section using the collected data so that generated evaluation values may become more consistent with the user's evaluation.

### BRIEF DESCRIPTION OF THE DRAWINGS

While the specification concludes with claims that particularly point out and distinctly claim that which is regarded as the presentation, details of embodiments of the invention may be more readily ascertained from the following detailed description when considered in conjunction with the following drawings wherein;

FIG. 1 is a schematic representation of an information processing system 10;

FIG. 2 shows a functional configuration of a server apparatus 20;

FIG. 3 shows a functional configuration of a user terminal 30;

FIG. 4 shows an example of a data structure of an evaluation value database 230;

FIG. 5 shows a first display example of a screen output by a difficulty evaluation section 330;

FIG. 6 shows a second display example of a screen output by the difficulty evaluation section 330;

FIG. 7 shows a third display example of a screen output by the difficulty evaluation section 330;

FIG. 8 shows a flowchart of a process in which the server apparatus 20 collects the user's difficulty evaluation values, and in which the server apparatus 20 updates the evaluation function;

FIG. 9 is a flowchart of a process in which the user terminal 30 computes and outputs the user's evaluation value;

FIG. 10, consisting of FIGS. 10A and 10B, shows scan trajectories along which display objects are scanned in Z-order;

FIG. 11 shows the details of a process illustrated generally in step S900;

FIG. 12 shows an example of a process which the server apparatus 20 performs for a document creator; and

FIG. 13 shows an example of a hardware configuration of an information processing apparatus 500 which functions as the server apparatus 20 or as the user terminal 30.

### DETAILED DESCRIPTION

A specific embodiment of the invention will be described to help explain the invention. The description of the specific embodiment should not be construed as limiting the scope of the invention. The scope of the invention is to be determined by the claims. In addition, every feature described in the embodiment is not always indispensable to use of the present invention.

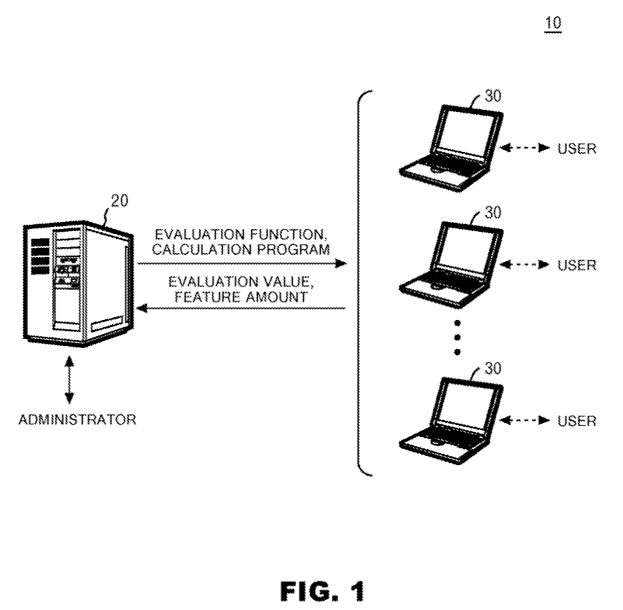

FIG. 1 shows a complete information processing system 10. The information processing system 10 includes a server apparatus 20 and a plurality of user terminals 30. The server apparatus 20 makes available, to each user terminal 30, functionality including a calculation program for computing a feature amount associated with a feature of each page included in a document. In addition, the server apparatus 20 also makes available, to each user terminal 30, the functionality of an evaluation program for computing an evaluation value representing how difficult it might be for a user to understand the contents of a document represented by audio output from a screen reader.

Each user terminal 30 is associated with one of a plurality of users and includes a screen reader for generating an audible representation of the contents of a document page. Each user terminal 30 generates an evaluation value for each page in a document specified by a user using the functionality of the calculation program and the evaluation program made available by the server apparatus 20 and outputs the evaluation value for each page to the terminal user. Thus, before the document is actually read aloud, the user can find out how difficult it is likely to be to understand the contents of each page if the screen reader is used for that page, and can choose whether a page is to be actually read aloud.

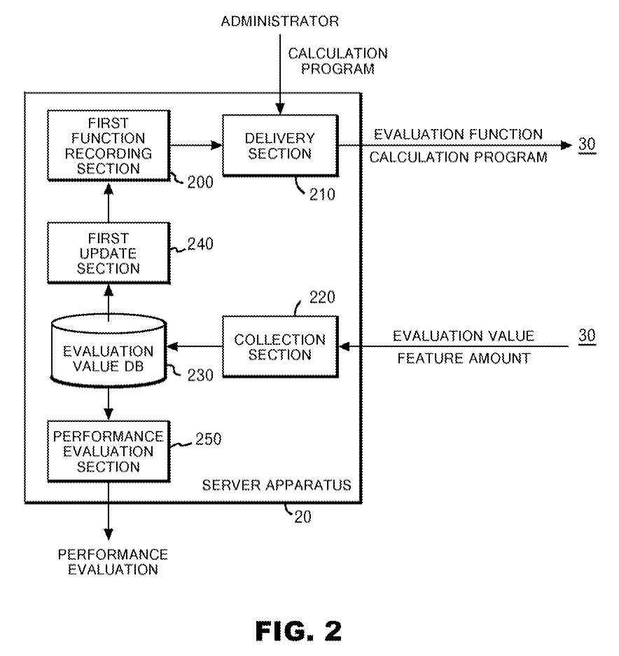

FIG. 2 shows a functional configuration of the server apparatus 20. The server apparatus 20 includes a first function recording section 200, a delivery section 210, a collection section 220, an evaluation value database 230 and a first update section 240. The first function recording section 200 stores an evaluation function in association with a user profile of a user for whom the evaluation function is used. The evaluation function serves to compute an the evaluation value representing the likely degree of difficulty of understanding the page based on the feature amount of the page. The user profile of a user includes, for example, the type of screen reader used by the user or the type of creation system used making a document page being evaluated.

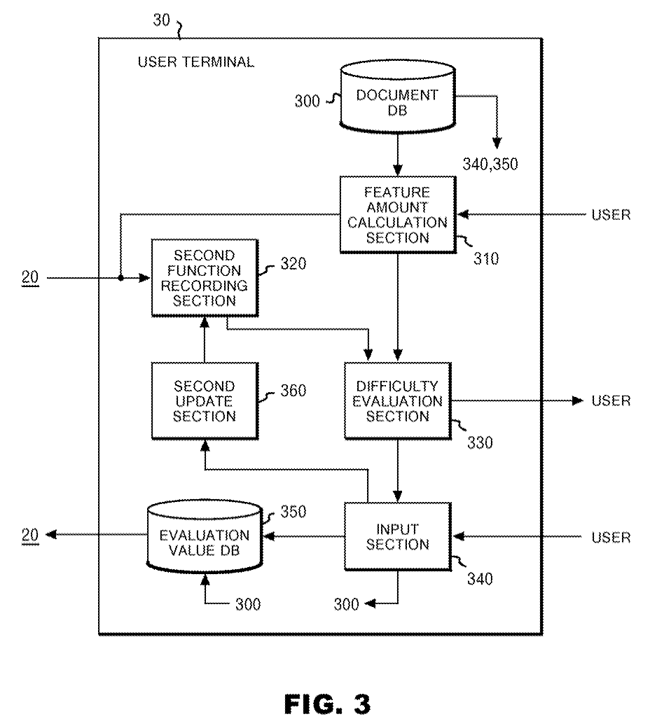

The delivery section 210 makes an evaluation function stored in the first function recording section 200 available to each of the user terminals 30. The evaluation function delivered to a certain user is one associated with the user profile of the user. Moreover, each time the first update section 240 updates an evaluation function, as will be described below, the delivery section 210 delivers the updated evaluation function to each of the plurality of user terminals 30, and thus causes a second function recording section 320 in the user terminal 30 (see FIG. 3) to record the updated evaluation function. In addition, when a new version of a calculation program for computing a feature amount is acquired from an administrator, the delivery section 210 may respond to this acquisition, and make the new version available to each of the plurality of user terminals 30

The collection section 220 collects user feedback; namely, the user's evaluation of the actual difficulty in understanding a page and the feature amount on the page, in association with the user profile of the user. Specifically, the collection section 220 may either collect actual user difficulty evaluation values and feature amounts when the number of the user's difficulty evaluation values recorded in the user terminal 30 reaches a predetermined level or collect them periodically regardless of the number of the evaluation values generated during the time period.

The evaluation value database 230 records user difficulty evaluations and feature amounts collected from the user by the collection section 220 in association with the user profile. In the first function recording section 200, the first update section 240 updates the evaluation function associated with each of the user profiles. Here, the evaluation function is updated on the basis of the evaluation value and the feature amount collected in association with the user profile.

In addition, the server apparatus 20 may include a performance evaluation section 250. The performance evaluation section 250 evaluates the performance level of each type of screen reader by using the user feedback evaluation values collected by the collection section 220. For example, in a case where the evaluation values corresponding to a certain type of screen reader are higher on the average than those corresponding to each of the other types of screen readers, the performance evaluation section 250 may rate the performance of the certain type of screen reader at a high level.

FIG. 3 shows a functional configuration of the user terminal 30. In addition to functioning as a screen reader, the user terminal 30 includes functionality for evaluating the degree of difficulty in understanding the contents of a document page by listening to an output voice representing the page. Specifically, the user terminal 30 includes a document database 300, a feature amount computation section 310, a second function recording section 320, a difficulty evaluation section 330, an input section 340, an evaluation value database 350 and a second update section 360. The document database 300 records a document created using a document creation system. The document may include a plurality of pages, and the pages may have structures different from one another. Moreover, each of the pages may include graphics as well as text. Furthermore, the graphics may include a plurality of display objects.

In response to an instruction from a user specifying a page, the feature amount computation section 310 computes the feature amount representing a feature of the specified page. This feature amount may be computed by scanning a plurality of display objects included in the specified page in a predetermined order; i.e., along a predetermined trajectory. The second function recording section 320 acquires and records the evaluation function from the first function recording section 200 in the server. The difficulty evaluation section 330 computes an evaluation value for the page by passing the feature amount computed by the feature amount computation section 310 to the evaluation function. The difficulty evaluation section 330 outputs the computed evaluation value for the user It is preferable that, the evaluation value be provided to the user before the document is read aloud by the screen reader. If the evaluation value computed by the difficulty evaluation section 330 is inconsistent with the user's evaluation of the difficulty, the input section 340 receives an input of the user's difficulty evaluation value.

The evaluation value database 350 records the user's difficulty evaluation value in association with the feature amount of the page. Here, the evaluation value database 350 is only one example of a page recording section of the present invention. The evaluation value database 350 may record each of a plurality of pages whose computed evaluation value is inconsistent with the user's own evaluation of the difficulty. On the basis of the inputted user's difficulty evaluation value of the pages and the feature amounts of the pages, the second update section 360 updates the evaluation function stored in the second function recording section 320 with the goal of the evaluation function generating evaluation values more consistent with the user's evaluation.

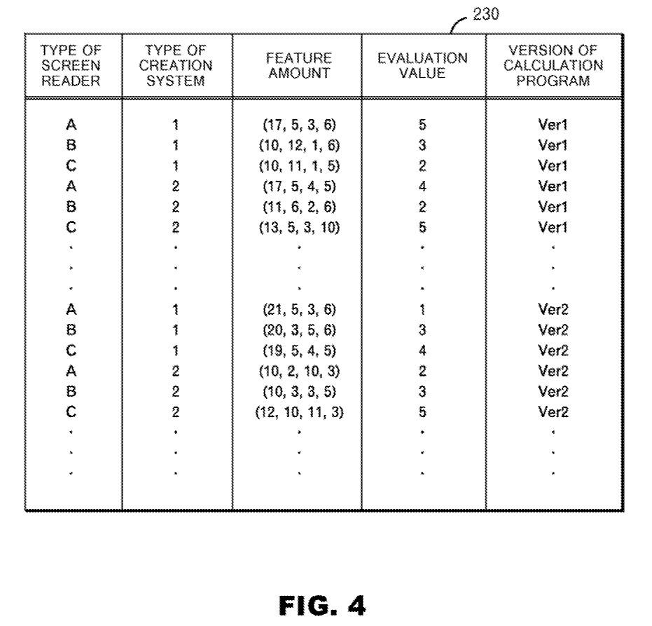

FIG. 4 shows an example of a data structure of the evaluation value database 230. In the evaluation value database 230, the feature amounts and the user's difficulty evaluation values which the collection section 220 collects from each of the user terminals 30 are recorded in association with both the user profile of the user and the version of a calculation program used for computing the feature amount. The user profile illustrated in FIG. 4 includes the type of screen reader (A,B, or C) and the type of creation system (1 or 2). The screen reader may not necessarily be a single piece of software and may be a part of certain software such as a plug-in for browser software. In this case, it is preferable that the types of software and plug-ins be distinguishable in the user profile. As another example, the screen reader may be one obtained by combining a plurality of software components. For example, the screen reader may include a conversion program for converting the data format of a document, and a text-to-speech program for producing audio based on the document after the conversion. In this case, it is preferable that each of the programs constituting the screen reader be distinguishable in the user profile.

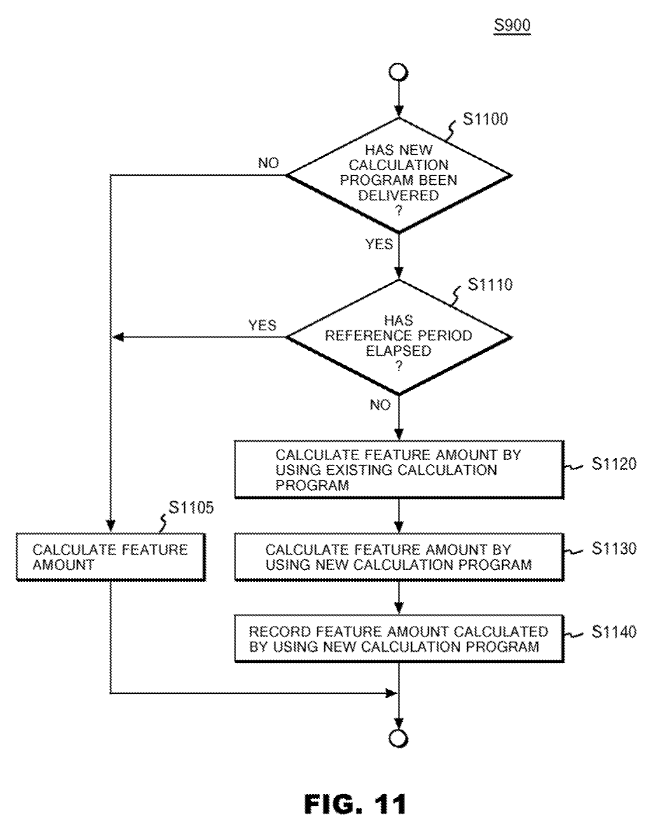

In addition, the feature amount recorded in the evaluation value database 230 may be vector data including a plurality of elements. The elements in one piece of vector data respectively show different features of one page. Furthermore, the evaluation value recorded in the evaluation value database 230 may be expressed, for example, by using a scale, that indicates the relative ease of understanding by listening to a voice. Alternatively, the evaluation value may be expressed by using one of continuous values based on a scale of 100. The version of a calculation program shows whether a new calculation program or an old calculation program was used for evaluating the feature amount during a transition period in which the calculation program is being updated. A process of referring to the version information will be described below by using FIG. 11.

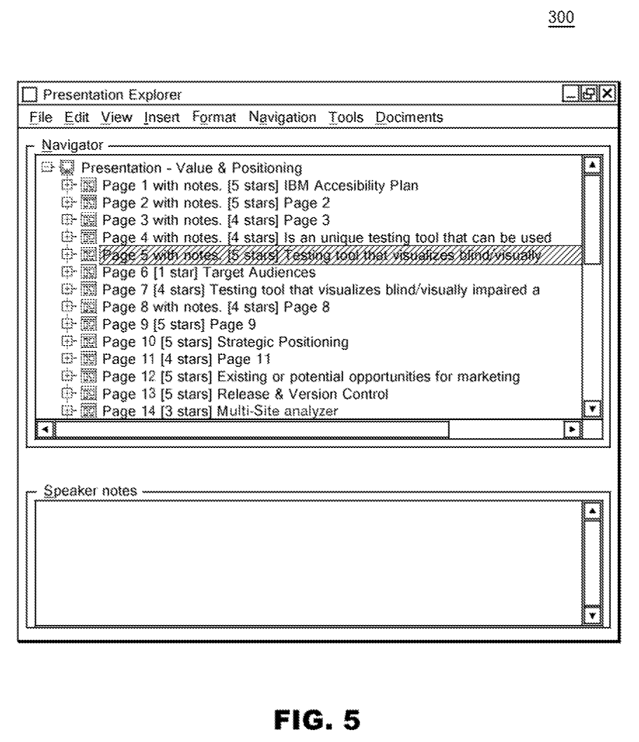

FIG. 5 shows a first example of a screen output by the difficulty evaluation section 330. The document in this first display example is a presentation package. This presentation package includes a plurality of pages, and the titles of the respective pages are shown on the screen. By using the function of the screen reader provided in the user terminal 30, a user can cause these titles to be read aloud. The difficulty evaluation section 330 causes the degree-of-difficulty evaluation value of each page to be displayed in association with the title of the page. For example, in FIG. 5, the text “5 stars” indicates that it is likely to be very easy to understand the contents. On the other hand, the text “1 star” indicates that it is likely to be very difficult to understand the contents.

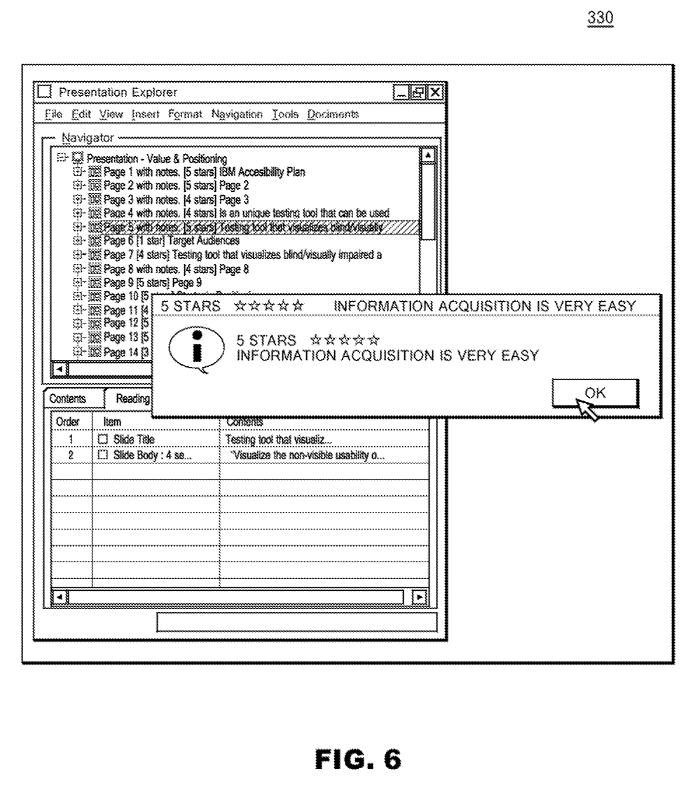

FIG. 6 shows a second example of a screen outputted by the difficulty evaluation section 330. This second display example illustrates a popup window displayed when a user specifies a certain page. To be more precise, when a user specifies a certain page, the difficulty evaluation section 330 causes the evaluation value of the page and what the evaluation value means to be displayed inside a popup window. By specifying the page, the user can determine the likely difficulty in understanding the contents of the page before the page is actually read aloud.

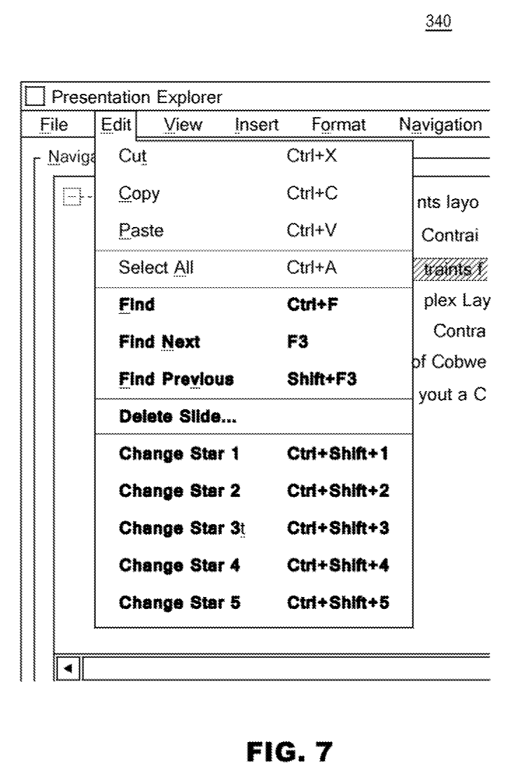

FIG. 7 shows a third example of an output by the difficulty evaluation section 330. This third example shows a screen displayed when the input section 340 receives an operation for changing the evaluation values. Upon receipt of an operation of selecting a menu (for example, the edit menu on the toolbar) for changing the evaluation values, the input section 340 causes the screen to display both clickable menu entries and associated hot key combinations for changing the evaluation values of the degree of difficulty. Here, Change Star 1 and the like are displayed. Thus, by letting the user select any of these entries, the input section 340 can receive an input of the user's difficulty evaluation value.

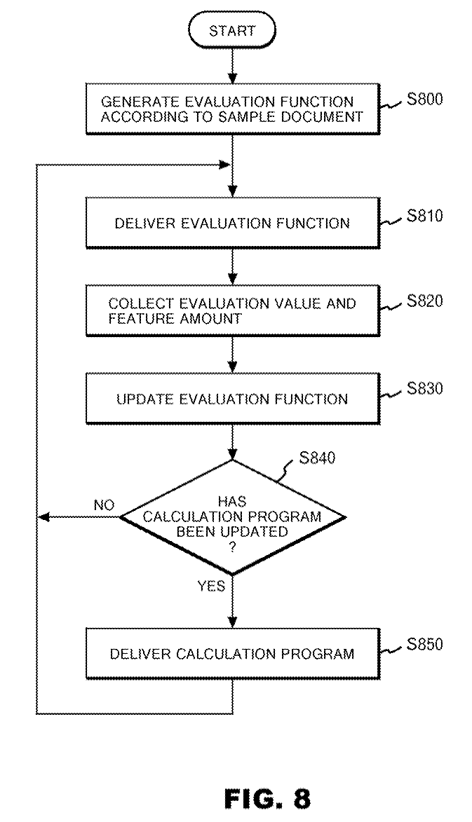

FIG. 8 is a flowchart, of a process in which the server apparatus 20 collects the user's difficulty evaluation values, and updates the evaluation function. The first update section 240 generates an evaluation function on the basis of a predetermined sample document, and records the evaluation function in the first function recording section 200 (S800). If an evaluation value is newly recorded in the first function recording section 200, or if the evaluation function recorded in the first function recording section 200 is updated, the delivery section 210 delivers the evaluation function recorded in the first function recording section 200 to each of the user terminals 30 (S810). If the evaluation value computed by the difficulty evaluation section 330 is inconsistent with the user's difficulty evaluation, the collection section 220 immediately collects, from each of the user terminals 30, both the user's difficulty evaluation value inputted to the input section 340, and the feature amount computed by the feature amount computation section 310 (S820). Alternatively, this collection may be made periodically.

The first update section 240 updates the evaluation function recorded in the first function recording section 200 on the basis of the feature amount and the user's difficulty evaluation value collected in association with the user profile so that the evaluation values generated by the updated evaluation function will hopefully be more consistent with the user's evaluation (S830). An example of details of a processing procedure will be described below. Firstly, the first update section 240 classifies the collected feature amounts and the collected user's difficulty evaluation values into groups of the respective user profiles. Subsequently, the first update section 240 generates an evaluation function for each of the groups thus classified by using a technique such as multiple regression analysis or machine learning (a neural network, decision tree learning, a support vector machine or the like). The generated evaluation function is the most likely function that would return the collected user's difficulty evaluation value by using the collected feature amount. The first update section 240 updates the existing evaluation function to the newly generated evaluation function.

The delivery section 210 determines whether the calculation program for computing the feature amount has been updated (S840). If the calculation program has been updated (S840: YES), the delivery section 210 delivers the updated calculation program to the user terminal 30 (S850), and then the processing is returned to step S810. In this way, a new evaluation function is delivered to the user terminal 30 every time the evaluation function is updated.

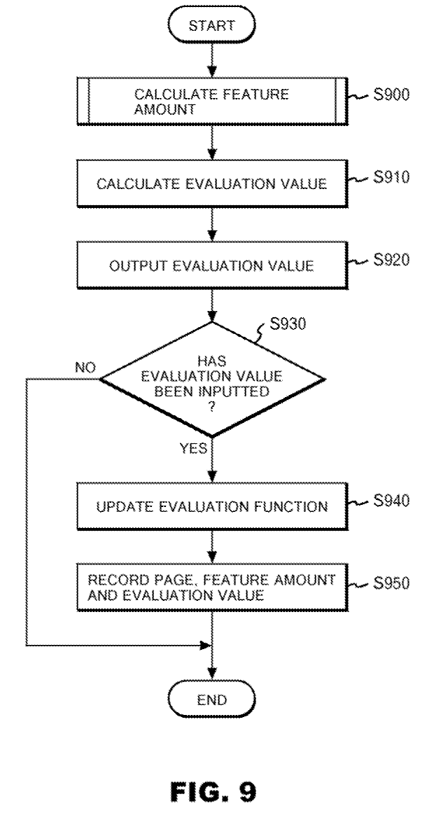

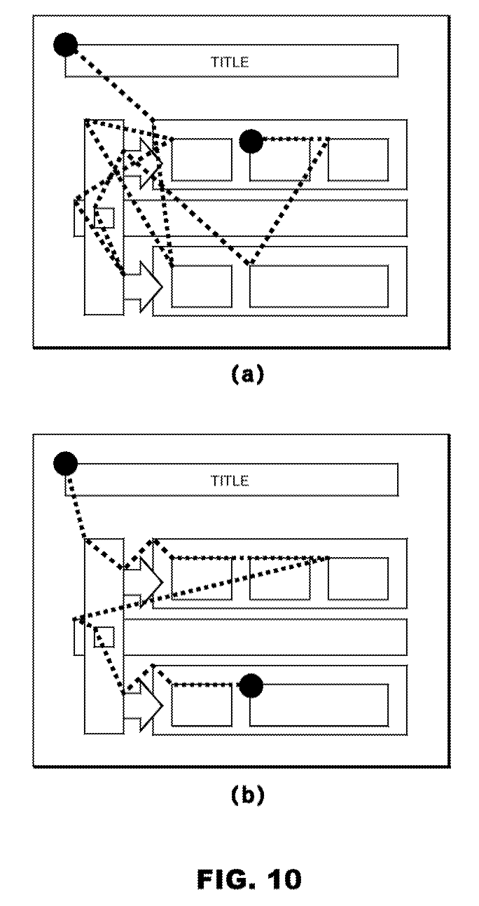

FIG. 9 shows a flowchart of a process in which the user terminal 30 computes and outputs the evaluation value. In response to an instruction from a user for specifying a page, the feature amount computation section 310 computes the feature amount of the specified page (S900). It is possible to compute the feature amount by using a scan trajectory along which a plurality of display objects included in the specified page are scanned sequentially. The details are shown in FIGS. 10A and 10B.

Each of FIGS. 10A and 10B shows a scan trajectory along which display objects are scanned in Z-order. The Z-order is an ordering of overlapping display objects. For example, the display objects are displayed sequentially overlapping one another from the background to the foreground in order in which the objects are created. In each of FIGS. 10A and 10B, shapes such as rectangles and arrow lines indicate the display objects, and a dotted line connecting these display objects to one another indicates the scan trajectory. In FIG. 10A, the scan trajectory is very complicated. Accordingly, the screen reader reading aloud in the Z-order reads aloud the display objects discretely regardless of relative positions in an X direction and in a Y direction on the screen. As a result, the order of reading aloud the display objects is largely inconsistent with a display structure which a sighted person intuitively perceives. On the other hand, in FIG. 10B, the scan trajectory is relatively linear. As a result, the order of reading aloud the display objects is more consistent with a display structure which a sighted person intuitively perceives.

For the purpose of detecting the inconsistency, as illustrated above, between the order of reading aloud and the display structure as a feature amount, the feature amount computation section 310 computes the feature amount by using a scan trajectory along which a plurality of display objects are scanned in the Z-order. For example, the feature amount may be computed according to the distance and angles in the trajectory. The details of this process will be described below. In one example thereof, the feature amount computation section 310 computes the distance between a first display object and a second display object scanned after the first display object. Here, the feature amount computation section 310 makes such a computation for each of the display objects. Then, in a case where the total or average distance thus computed is longer, the feature amount computation section 310 computes the feature amount as being larger than that in a case where the total or average distance is shorter. In other words, where the scan trajectory in a certain page is complicated, and thus long, the feature amount computation section 310 rates the page as one having a feature in which the contents of the page may not be easily understood.

In another example, the feature amount computation section 310 computes an angle of a line connecting first and second sequentially scanned display objects to another line connecting to second and third sequentially scanned display objects. Here, the feature amount computation section 310 makes such a computation for each triplet of the display objects. If the absolute value of the total or average angle thus computed is small (meaning the trajectory makes sharp turns between overlapping objects, the feature amount computation section 310 computes the feature amount higher than that in a case where the absolute value of the total or average angle is smaller. For example, a formula for computing the feature amount is shown as Formula 1 below. By using this formula, the feature amount computation section 310 can compute a large feature amount in a case such as FIG. 10A in which parts of the scan trajectory overlap one another, and can compute a small feature amount in a case such as FIG. 10B in which parts of the scan trajectory do not overlap one another.

$$\begin{matrix}[ Formula 1 ] & \\ max ( abs ( {\sum }_{i = 1}^{k} Aj ) \vert 1 \leq k \leq N - 2 ) & Formula 1\end{matrix}$$

The process illustrated by referring to FIGS. 10A and 10B is one example. The feature amount computation section 310 may compute a plurality of feature amounts by using methods, and may input, to the evaluation function, a vector consisting of the computed feature amounts. Examples of methods for computing the feature amounts will be described below.

### (1) The number of display objects, the area size thereof and the like

The feature amount computation section 310 classifies display objects included in a page as being of a plurality of types. This classification is made according to criteria, such as whether or not each of the display objects includes text data and/or alternative text data, and whether or not the display object is a placeholder indicating either a page title and an outline text. Thereafter, the feature amount computation section 310 computes, as a feature amount, either the number of the display objects in each of the criteria, or a ratio value that reflects the area occupied by the display objects in each of the criteria relative to the size of the whole page. In this way, it is possible to express, as a feature amount, whether or not a display object has a certain kind of feature, and if any, what kind of feature a display object with a large area (i.e., it is highly likely to be important) has.

### (2) The number of letters and the amount of change of fonts in text

The feature amount computation section 310 may compute, as a feature amount, the total number of letters included in a page, or the average or total number of letters included in each display object. Moreover, the feature amount computation section 310 may compute, as a feature amount, the number of times font types or font colors are changed as display objects are read aloud to the end of the Z-order. This is because it is generally difficult for a sight-impaired person to understand a sentence including a small number of letters in addition, it is also difficult to translate information expressed by using font colors and font type changes into audio data.

### (3) The numbers of objects and letters in each level of grouping hierarchy

In some cases, a display object has a structure formed by grouping a plurality of display objects. To be more precise, if a document creator performs an operation for grouping a plurality of display objects, then the document creator can treat (change the position of, enlarge or reduce the size of, or the like) the plurality of display objects as if they were one display object. In addition, a display object may have a structure including nested groups of display objects.

The feature amount computation section 310 may compute the number of hierarchy levels of a group included in a certain page, or may compute any of the average and the variance of the number of display objects or letters included in each hierarchy level of a group, and then may output the computed result as a feature amount. This is because, in general, a sight-impaired person often has a difficulty in understanding the contents of a page in a case where the page has an excessively deep hierarchy or has no hierarchy at all.

### 4) Others

In another example, the feature amount computation section 310 may compute information on whether or not a page includes animation as a feature amount. In a case where display objects are displayed overlapping one another, the feature amount computation section 310 may compute the feature amount on the basis of the area where the display objects overlap one another. The reason for this is that it is often difficult for a sight-impaired person to understand the contents of a page that includes heavy use of animation or significant overlapping of display objects.

Referring back to FIG. 9, in a transition period during which the calculation program for finding the feature amount is being modified, the feature amount computation section 310 performs, during the processing in step S900, another process for reducing a problem which occurs due to the modification. The process for minimizing a problem will be described in detail later by referring to FIG. 11. Following step S900, the difficulty evaluation section 330 passes the feature amount computed by the feature amount computation section 310 to the delivered evaluation function, and thereby computes the evaluation value (S910). Then, the difficulty evaluation section 330 outputs the evaluation value for the user (S920). The input section 340 receives an input of the user's difficulty evaluation value which is different from the evaluation value computed by the difficulty evaluation section 330 (S930).

If the input section 340 receives the input of the user's difficulty evaluation value (S930: YES), the second update section 360 updates the evaluation function recorded in the second function recording section 320 using the user's difficulty evaluation value of each page and the feature amount of the page (S940). With this update, the evaluation function is modified so that the evaluation function would provide an evaluation value more consistent with the user's evaluation. In association with the feature amount of the page, the evaluation value database 350 stores the evaluation values provided by the user (S950). In addition, the evaluation value database 350 may store each of a plurality of pages, of which the computed evaluation value is inconsistent with the user's evaluation of the difficulty, in association with the user's difficulty evaluation value of the page input to the input section 340.

FIG. 11 shows the details of the process referenced in step S900. In a case where the user terminal 30 newly receives a delivery of a second version of a calculation program while already having a first version of the program, using a previously-generated evaluation function without modification sometimes causes a problem. Accordingly, it is desirable that a new evaluation function be generated. However, the user's evaluation is not reflected in the new evaluation function. As a result, the new evaluation function sometimes returns an inaccurate evaluation value. To avoid this, the user terminal 30 performs the following process within a predetermined reference period after receiving the delivery of the second calculation program. Here, the reference period is regarded as the transition period for changing the calculation programs.

The feature amount computation section 310 judges whether or not a second version of a calculation program has been received (S1100). If a second version has been received (S1100: YES), the feature amount computation section 310 judges whether the reference period has elapsed since the second version was received (S1110). If a second version has not been received, or if the reference time has already elapsed following delivery of the second version, the feature amount computation section 310 computes the feature amount by using the latest version of the calculation program, and then terminates the process (S1105).

If the reference period has not elapsed (S1110: NO), the feature amount computation section 310 performs the following process. Incidentally, if a newer second calculation program is delivered before the reference period elapses, the feature amount computation section 310 nullities the process performed with the existing second calculation program, and performs the following process for the new second calculation program.

Firstly, the feature amount computation section 310 computes a feature amount by using the first calculation program (S1120). Then, the difficulty evaluation section 330 computes the evaluation value from the feature amount computed by using the first calculation program in step S910 as described above. Next, the feature amount computation section 310 computes a feature amount by using the second calculation program (S1130). The feature amount computation section 310 stores, in the document database 300, the feature amount, computed by using the second calculation program in association with both of the evaluation value computed by using the first calculation program in step S910, and information indicating the version of the second calculation program (S1140). Note that, in a case where an input of a new user's difficulty evaluation value is received due to the inconsistency between the computed evaluation value and the user's evaluation, the feature amount is stored in association with the new user's difficulty evaluation value.

The server apparatus 20, for example, periodically collects the feature amounts, the evaluation values and information indicating the versions, that are stored in the document database 300. Specifically, the collection section 220 collects, from the document database 300, the evaluation values computed by the difficulty evaluation section 330 or the user's difficulty evaluation values input to the input section 340; and the feature amounts which the feature amount computation section 310 generates using the second version of the calculation program. In response to this, the first update section 240 generates a second evaluation function corresponding to the second version of the calculation program on the basis of the collected evaluation values and the collected feature amounts. In this way, the evaluation accuracy of the second evaluation function corresponding to the new calculation program can be enhanced from the point where the new calculation program is delivered to the point where the reference period elapses.

In addition to the foregoing process, the server apparatus 20 may make use of each page stored in the document database 300 (that is, the page for which an evaluation value computed by using the first evaluation function is inconsistent with the user's evaluation) in order to enhance the evaluation accuracy of the second evaluation function. To be more precise, by using the second calculation program, the feature amount computation section 310 computes the feature amount of each page already stored in the document database 300. It is desirable that this computation process be performed only while the processing load of the user terminal 30 is lower than a predetermined reference load. Then, the collection section 220 collects the feature amount of each page stored in the document database 300, where the feature amount is computed by using the second calculation program, so that the feature amount associated with the evaluation value (computed by using the first evaluation function or the user's difficulty evaluation value) is stored in association with the page in the document database 300. Thus, for the purpose of enhancing the evaluation accuracy of a new evaluation function, the foregoing process makes it possible to utilize a page of which evaluation value computed by using the first evaluation function is previously inconsistent with the user's evaluation.

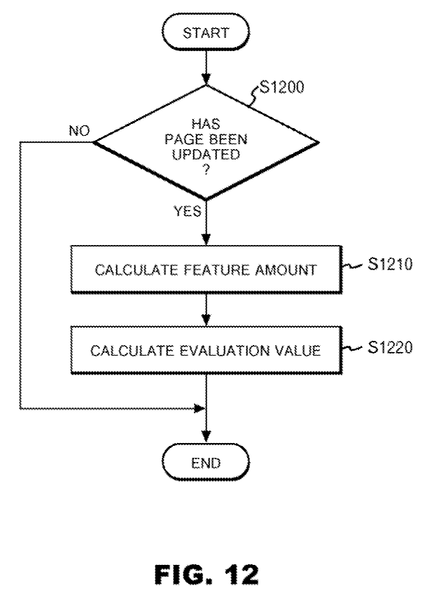

FIG. 12 is an example of a process which the server apparatus 20 performs for a document creator. Descriptions will be given of a processing example where the document creator uses the user terminal 30. In this example, the user terminal 30 also functions as a document creation system. Every time the user terminal 30 updates a page in response to an instruction by the document creator (S1200: YES), the feature amount computation section 310 recomputes the feature amount representing a feature of the updated page (S1210). Subsequently, the difficulty evaluation section 330 computes the evaluation value of the page by passing the recomputed feature amount to the evaluation function, and then outputs the evaluation value for the document creator of this document (S1220).

The evaluation value may be computed every time the page is updated. This allows the document creator to edit the page while watching the effect on the evaluation value, making it easier for the document creator to create a document which a sight-impaired person can more easily understand. Note that other techniques relating to the document creation for a sight-impaired person can be additionally incorporated in the user terminal 30. For example, the user terminal 30 can store requirements to be satisfied so that a document can be more easily understood by a sight-impaired person. The requirements can include, for example, the designation of a character string to be read aloud instead of an image. Another example of stored requirements may be that a plurality of display objects constituting a table are recorded in association with information (a tag or the like) indicating the table structure instead of table contents apparently dispersed at random being described. Another requirement may be that a character string representing a title is recorded in association with information (a placeholder or the like) indicating that the character string represents the title. Then, every time a page is updated, the user terminal 30 judges whether or not the updated page satisfies the requirements. In a case where the requirements are not satisfied, the user terminal 30 identifies the currently unsatisfied requirements to the document creator, which encourages the document creator to improve the document.

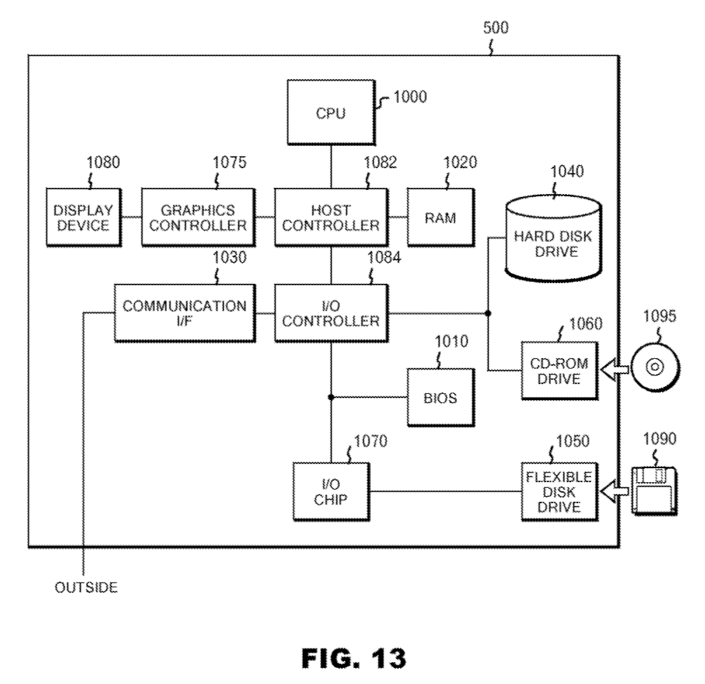

FIG. 13 illustrates a hardware configuration of an information processing apparatus 500 which functions as the server apparatus 20 or the user terminal 30. The information processing apparatus 500 includes a central processing unit or CPU subsystem and an input/output subsystem. The CPU subsystem includes a CPU 1000, a random access memory or RAM 1020 and a graphics controller 1075, all of which are connected to one another via a host controller 1082. The input/output subsystem includes a communication interface 1030, a hard disk drive 1040 and a CD-ROM drive 1060, all of which are connected to the host controller 1082 via an input/output controller 1084. The input/output subsystem further includes a BIOS 1010, a flexible disk drive 1050 and an adapter taking the form of I/O chip 1070. The BIOS 1010 and the chip 1070 are connected to the input/output controller 1084,

The host controller 1082 connects both the RAM 1020 and the graphics controller 1075 to the CPU 1000. The CPU 1000 is used to execute programs stored in the BIOS 1010 and the RAM 1020 and controls each of the components. The graphics controller 1075 obtains image data generated by the CPU 1000 or the like in a frame buffer provided to the inside of the RAM 1020, and displays the obtained image data on a display device 1080. Alternatively, the graphics controller 1075 may internally include a frame buffer which stores the image data generated by the CPU 1000.

The input/output controller 1084 connects the host controller 1082 to the communication interface 1030, the hard disk drive 1040 and the CD-ROM drive 1060, all of which are higher-speed input/output devices. The communication interface 1030 communicates with external devices via a network. The hard disk drive 1040 stores programs and data to be used by the information processing apparatus 500. The CD-ROM drive 1060 reads a program or data from a CD-ROM 1095, and provides the read-out program or data to the RAM 1020 or the hard disk 1040.

Moreover, the input/output controller 1084 is connected to the BIOS 1010 and to lower-speed input/output devices such as the flexible disk drive 1050 through the input/output chip 1070. The BIOS 1010 stores programs, such as a boot program executed by the CPU 1000 at a start-up time of the information processing apparatus 500 and a configuration program for the hardware components of the information processing apparatus 500. The flexible disk drive 1050 reads a program or data from a flexible disk 1090, and provides the read-out program or data to the RAM 1020 or the hard disk drive 1040 via the input/output chip 1070. The input/output chip 1070 is connected to the flexible disk drive 1050 and may also support various kinds of input/output devices through various ports, for example, parallel, serial, keyboard, mouse, USB, Firewire, etc. ports.

A program to be provided to the information processing apparatus 500 is provided by a user with the program stored in a recording medium such as flexible disk 1090, CD-ROM 1095 and possibly on a solid state memory device such as a memory key. The program is read from the recording medium via the input/output chip 1070 and/or the input/output controller 1084, and is installed in the information processing apparatus 500. Thus, the program is executed. Since an operation in which the program causes the information processing apparatus 500 to execute is identical to the operation of the server apparatus 20 or of the user terminal 30 as already described by reference to FIGS. 1-12, the description thereof is omitted.

The program described above may be stored in an external storage medium. In addition to the flexible disk 1090 and the CD-ROM 1095, examples of suitable storage media include an optical recording medium such as a DVD, a magneto-optic recording medium, a tape medium, and a semiconductor memory such as an IC card. Alternatively, the program may be provided to the information processing apparatus 500 via a network, by using, as a recording medium, a storage device such as a hard disk and a RAM, which is provided to a server system connected to a private communication network or a public network such as the Internet.

As has been described above, the information processing system 10 of this embodiment makes it possible to properly evaluate the degree of difficulty in understanding a document which includes graphics, and for which evaluation on the degree of difficulty in understanding has been difficult. In this system, the function for evaluating the degree of difficulty is appropriately updated on the basis of evaluations collected from a plurality of users. Accordingly, the degree of difficulty can be properly evaluated even for a user who has just begun to use a screen reader. In addition, users' evaluations are collected in a state where the users'evaluations are classified by user profile including information on a type of screen reader and the like. Using the collected users' evaluations makes it possible to further enhance the evaluation accuracy of the degree of difficulty. Furthermore, in a case where the calculation program for computing the feature amounts is updated, the transition period for an update is set up, so that the evaluation accuracy can be maintained and even improved after the update.

The present invention has been described by reference to a specific embodiment. However, the scope of the present invention is not limited to the above-described embodiment. It may be obvious to one skilled in the art that various modifications and improvements can be made to the embodiment. Therefore it is intended that both the described embodiment, and ail variations and modifications that may occur to those skilled in the art shall be within the scope of the present invention.

What is claimed:

1. A system for evaluating the degree of difficulty a user is likely to encounter in trying to understand the contents of a document page by listening to a voice provided by a screen reader, the system comprising:
a first function recording section providing an evaluation function for computing an evaluation value of a page based on a feature amount representing a feature of the page;
a collection section that collects both a user-provided difficulty evaluation value and a feature amount of each of at least one of pages when evaluation value generated by the evaluation function is inconsistent with the user-provided difficulty evaluation value; and
a first update section which updates the evaluation function provided by the first function recording section using the collected data.

2. A system according to claim 1, wherein,
for each different type of screen reader, the first function recording section provides an evaluation function,
for each different type of screen reader, the collection system collects both a user-provided difficulty evaluation value and a feature amount of each of one or more pages when evaluation value generated by the evaluation function is inconsistent with the user-provided difficulty evaluation value, and
the first update section updates the evaluation function corresponding to each type of screen reader using the collected data associated with that type of screen reader.

3. A system according to claim 2, wherein,
for each type of document creation system used for creating a document, the first function recording section provides an evaluation function for evaluating the difficulty a user may encounter when trying to understand a document that is prepared using the document creation system by listening to a voice output from a screen reader,
for a document prepared by each type of document creation system, the collection system collects both a user-provided difficulty evaluation value and a feature amount at least one of pages when evaluation value generated by the evaluation function is inconsistent with the user-provided difficulty evaluation value, and
the first update section updates the evaluation function corresponding to each type of document creation system using the collected data associated with that type of document creation system.

4. A system according to claim 2, further including a performance evaluation section that evaluates the performance level of each type of screen reader on the basis of the user's difficulty evaluation value collected by the collection section.

5. A system according to claim 1, further comprising:
a feature amount computation section that computes the feature amount of a page specified by a user by scanning a plurality of display objects included in the page in a predetermined order;
a difficulty evaluation section that computes the evaluation value of the page by passing the computed feature amount to the evaluation function, which generates and outputs the evaluation value to a user, and
wherein the system collects the user's difficulty evaluation value for the page if the generated evaluation value is inconsistent with the user's difficulty evaluation value.

6. A system according to claim 5, wherein the feature amount computation section computes a feature amount of a page according to the trajectory along which the plurality of display objects included in the specified page are scanned in a Z-order in a case where the display objects overlap one another.

7. A system according to claim 5, wherein the feature amount computation section computes the distance between successive pairs of display objects that occur in sequence in the order of scanning, and
where if the computed distances exceed a predetermined threshold, the feature amount computation section generates a larger feature amount than would he the case where the computed distances did not exceed the threshold.

8. A system according to claim 5, wherein,
with respect to successive triplets of display objects, the feature amount computation section computes the angle between a line connecting a first one of the display objects to a second one of the display objects and a line connecting the second of the display objects to a third display object, and
where the total or average angle thus computed exceeds a threshold, the feature amount computation section generates a smaller feature amount than would be the case where the computed distances did not exceed the threshold.

9. A method for evaluating the degree of difficulty a user is likely to encounter in trying to understand the contents of a document page by listening to a voice provided by a screen reader, the method comprising the steps of:
using an evaluation function, generating an evaluation value of a document page based on a feature amount representing a feature of the page;
collecting both a user-provided difficulty evaluation value and a feature amount for the page when evaluation value generated by the evaluation function is inconsistent with the user-provided difficulty evaluation value; and
updating the evaluation function using the collected data.

10. A method according to claim 9 wherein different types of screen readers may be employed by a user and a different evaluation function is provided for each different type of screen reader, said method comprising the steps of:
using an evaluation function specific to a type of screen reader, generating an evaluation value of a document page based on a feature amount representing a feature of the page;
for each different, type of screen reader, collecting both a user-provided difficulty evaluation value and a feature amount of a page read using that type of screen reader when evaluation value generated by the evaluation function is inconsistent with the user-provided difficulty evaluation value; and
updating the evaluation function for that type of screen reader using the collected data related to that type of screen reader.

11. A system according to claim 10, wherein different document creation systems are used to create the document pages and a different evaluation function is provided for each different type of document creation system
for each type of document creation system used for creating a document, using the evaluation function for that type of document creation system to generate an evaluation value representing the difficulty a user may encounter when trying to understand a document that is prepared using the document creation system by listening to a voice output from a screen reader;
collecting both a user-provided difficulty evaluation value and a feature amount at least one of pages for a document prepared by each type of document creation system when the evaluation value generated by the evaluation function is inconsistent with the user-provided difficulty evaluation value; and
updating the evaluation function for each type of document creation system using the collected data associated with that type of document creation system.

12. A method according to claim 10 including the additional step of evaluating the performance level of each type of screen reader on the basis of the user's difficulty evaluation value collected by the collection section.

13. A method according to claim 9, comprising the additional steps of:
computing a feature amount of a page according to a trajectory along which a plurality of display objects included in the page are scanned in a predetermined order; and
computing the evaluation value of the page using the computed feature amount and the evaluation function.

14. A method according to claim 13, wherein the feature amount computation section computes a feature amount of a page according to the trajectory along which the plurality of display objects included in the specified page are scanned in a Z-order in a case where the display objects overlap one another.

15. A method according to claim 13, wherein the step of computing the feature amount comprises the steps of:
selecting a pair of display objects that occur in sequence in the order of scanning;
computing the distance between the two objects in the pair;
repeating the preceding steps for successive pairs of display objects until the entire trajectory has been scanned; and
increasing the feature amount if the cumulative computed distances exceed a threshold value.

16. A method according to claim 13 wherein the step of computing the feature amount comprises the steps of:
selecting a first triplet of display objects that occur in sequence in the order of scanning;
computing the included angle between a first line from the first object of the triplet to the second object of the triplet and a second line from the second object of the triplet to the third object of the triplet;
repeating the preceding steps for successive triplets of display objects until the entire trajectory has been scanned,
increasing the feature amount if the cumulative included angles are less than a threshold value.

17. A computer program product comprising a machine readable medium embodying program instructions for evaluating the degree of difficulty a user is likely to encounter in trying to understand the contents of a document page by listening to a voice provided by a screen reader, said program instructions when executed in a computer causing the computer to:
use an evaluation function to generate an evaluation value of a document page based on a feature amount representing a feature of the page;
collect both a user-provided difficulty evaluation value and a feature amount for the page when the evaluation value generated by the evaluation function is inconsistent with the user-provided difficulty evaluation value; and
update the evaluation function using the collected data.

18. A computer program product as set forth in claim 17 wherein different types of screen readers may be employed by a user and a different evaluation function is provided for each different type of screen reader, said program instructions including instructions that when executed in the computer will cause the computer to:
using an evaluation function specific to a type of screen reader, generate an evaluation value of a document page based on a feature amount representing a feature of the page;
for each different type of screen reader, collect both a user-provided difficulty evaluation value and a feature amount of a page read using that type of screen reader when evaluation value generated by the evaluation function is inconsistent with the user-provided difficulty evaluation value, and
update the evaluation function for that type of screen reader using the collected data related to that type of screen reader.

19. A computer program product, as set forth in claim 17 wherein different types of document creation systems may be used in creating the document pages to be evaluated and a different evaluation function exists for each different type of document creation system, said program instructions including instructions that will, when executed in a computer, cause the computer to:
for each type of document creation system, use the evaluation function for that type of document creation system to generate, an evaluation value for at least one page,
for each type of document, creation system, collect, both a user-provided difficulty evaluation value and a feature amount if the evaluation value generated by the evaluation function is inconsistent with the user-provided difficulty evaluation value, and
update the evaluation function for each type of document creation system using the collected data associated with that type of document creation system.
